(19) United States
(12) Patent Application Publication
(10) Pub. No.: US 2016/0265265 A1
(43) Pub. Date: Sep. 15, 2016

(54) FLEXIBLE SPACER FOR DOUBLE-GLAZING

(71) Applicant: Luca MERLO, Gallarte (Varese) (IT)

(72) Inventor: Luca MERLO, Gallarate (Varese) (IT)

(21) Appl. No.: 15/031,411

(22) PCT Filed: Oct. 21, 2014
(86) PCT No.: PCT/IT2014/000275

§ 371 Date: Apr. 22, 2016

(30) Foreign Application Priority Data
Oct. 24, 2013 (IT) MN2013U000010

(51) Int. Cl. E06B 3/663; E06B 3/54; E06B 3/677; E06B 3/96; E06B 3/673; E06B 3/66

(52) U.S. Cl. CPC E06B 3/663; E06B 3/67326; E06B 3/6608; E06B 3/6775; E06B 3/9616; E06B 3/67391; E06B 3/5454; E06B 3/67317; E06B 3/67321

(57) ABSTRACT

A description is made of a flexible spacer for double glazing made of Polyisobutylene elastomer or butyl rubber IIR (simple or halogenated), suitably loaded with both reinforcing and inert fillers. The spacer can be cross-linked with sulphur or peroxides. The spacer is impermeable to moisture and has high low thermal conductivity gas sealing capacity, and incorporates moisture absorbing material. In particular, the spacer features—on each side wall—at least a small wave (13a) positioned immediately above the accumulation area of the internal or primary sealant (15) so as to ensure an optimal adhesion to the glass of the double/triple glazing unit within which the spacer is fitted and features at least one recess (13b), with a configuration such as to allow the external sealant to penetrate and create a strong mechanical bond between the two materials.

### TECHNICAL FIELD

The present invention relates to a flexible spacer for insulating double/triple glazing for high energy efficiency doors and windows, and in particular to sealed double/triple glazing units with multiple layers of glass (usually double or triple window panes) and more in particular to double/triple glazing units with insulating and flexible spacer.

### BACKGROUND ART

As is known, “glass” for doors and windows called IGU—Insulating Glass Unit commonly known as double/triple glazing unit consists of at least two glass panes, separated by one or more spacer elements and hermetically sealed along the perimeter to enclose the air inside.

More in detail, the glass panes generally used may be of clear and coloured float glass, float glass coated on the outer sides, float glass coated on the inner sides whose coating must be removed in the area in contact with the sealants, coated glass where the coating or enamel on one or both inner sides in contact with the sealants does not need to be removed, wired glass (clear or texture), acid-etched glass, heat-treated glass, laminated glass, moulded glass, enamelled glass (with enamel on the outer side) and glass frosted on the outer sides.

Current spacers are of the type entirely made of metal such as aluminium and steel, plastic with metal coating in the area in contact with the sealant, plastic and flexible material without metal coating, with incorporated desiccant.

Desiccant material such as molecular sieves or other materials are used to absorb the humidity between the two panes of glass and the humidity that may penetrate over time from the outside.

In particular, the sealing material is divided into internal sealant (or primary), such as poly-iso-butylene (butyl), and external sealant (or secondary), such as polysulphide, silicone (mono or bi-component), polyurethane (mono or bi-component) or polyisobutyl (hot melt).

Finally, there is a fluid that fills the space between the two panes, such as air, gas or gas mixtures other than air.

As previously mentioned double/triple glazing units are made up of one or more parallel panes of glass, positioned at constant distance and the space between the glass panes is sealed along the perimeter of the glass to enclose the air. To maintain a constant distance between the panes, spacer bars—or spacers—are used, positioned along the perimeter of the glass panes.

As is known, the first spacers for double/triple glazing units were introduced in the 80s, and were made of hollow aluminium profiles; these were followed by stainless steel spacers obtained through hot extrusion or by rolling and forming flat metal strips. The internal cavity of the spacers is filled with substances that absorb the humidity of the air enclosed in the insulating glass unit, and the humidity that may penetrate over time from the outside.

The metal spacers are cut to size and assembled in a typically rectangular shape using corner connectors.

Once the glass panes and spacers have been positioned, the double/triple glazing unit is sealed along the perimeter of the panes using mono or bi-component sealants (internal and external). The mono-component sealants, generally used by double/triple glazing manufacturers are characterised by structural resistance, air tightness and resistance to the humidity contained in the unit, and include thermoplastic materials such as butyl as well as thermosetting materials such as polysulphides, polyurethanes and silicone sealants. In general, thermosetting sealants are more permeable to air humidity than thermoplastic sealants.

In double sealed double/triple glazing units, the internal sealant (usually polyisobutylene) has a waterproofing action against atmospheric humidity while the external sealant guarantees stability and resistance to the whole unit. In general, for this type of double/triple glazing unit, the internal butyl sealant is applied to the sides of the spacer frame adjacent to the glass panes.

The need to reduce the value of linear thermal transmittance along the perimeter of the double/triple glazing unit has led manufacturers to change from metal spacers to “warm edge” spacers.

The “warm edge” spacer frame is made by bending it with a special machine, called “profile bender”, when corner connectors are not used to achieve rectangular double/triple glazing units. The latest generation rigid warm edge spacers can be bent at an angle greater that a right angle and maintain the capacity to retain the internal gases and impermeability to humidity, since the external protective barrier can be deformed without cracking or breaking. The frame is usually closed with a plastic or metal linear connector. Before the “butyl application” operation, that seals the frame, the latter is generally filled with desiccant salts by making a passage hole on the base of the spacer, which is then hermetically closed.

The spacer frame thus made is then placed between two glass panes along the outer perimeter; this is followed by a pressing operation (sometimes coupled to heating), to ensure that the polyisobutylene (internal sealant) is compressed and adheres in a continuous manner to the glass surface. In the case of double/triple glazing units for high energy saving performance filled with noble gas, an additional gas input hole is made, which is also subsequently hermetically sealed. Finally, the last operation in the production of a double/triple glazing unit is the application of a secondary sealant—typically a thermosetting one such as silicone, polysulphide or polyurethane—along the perimeter channel facing outwards between the two glass panes.

Double sealing is generally used on automated production lines of double/triple glazing units, where the internal primary sealant is used as adhesive to hold in place the glass panes on the conveyor belts and during handling, while the external sealant crosslinks to give mechanical and structural strength to the unit.

In addition to the above, in recent years the production of insulating glass has evolved towards compositions that provide high thermal insulation performance, as the market increasingly requires double/triple glazing units with thermal transmittance values U_{g} close to and lower than 1.0 W/(m2*K); this value is then used by door and window manufacturers to determine the total thermal transmittance value of the window or door.

To improve the thermal performance of the glazing units, there is a progressive tendency to manufacture glazing units with additional glass panes (triple, quadruple), where one or more panes are coated with a low-emissivity coating in order to reduce the loss of heat by radiation; the internal cavities between the glass panes are filled with an inert gas such as argon, generally krypton, to further reduce thermal conductivity and convective heat loss.

As described above, the spacers, currently present on the market, are of the entirely metal (usually stainless steel) type, rigid plastic with external metal coating in the area of contact with the secondary or external sealants (e.g. Polypropylene, Polycarbonate combined with stainless steel or aluminium sheets), flexible organic material with incorporated desiccant: elastomeric EPDM or silicone foam protected at the back or rigid plastic without metal coating.

Nevertheless, while performing their task, the spacers currently used present various drawbacks especially in terms of achieving high thermal performance.

A first drawback encountered with double/triple glazing units with traditional sealing, incorporating a conductive metal spacer, is that it creates a thermal bridge between the layers of glass, which may result in condensation along the perimeter and even in the formation of ice in extreme winter weather.

Another drawback derives from the fact that with the conventional double/triple glazing units, the percentage of heat loss through the external sealant is of approximately 5% of the total heat loss from a standard size window. For high thermal performance glazing units, characterised by the use of rigid warm edge spacers, this percentage of heat loss is 15% or even higher.

In addition, the low-emissivity screens intercept part of the sun radiation, causing the inside of the double/triple glazing unit to heat. On sunny but cold days, the central part of the glass may heat up and expand; such expansion is prevented by the outer area of the glass, which is at a much lower temperature, creating high stress in the glass pane. In very low winter temperatures, this can give rise to cracks and breakages in the glass.

Another drawback derives for the fact that when the low emissivity coatings are on the internal sides of the double/triple glazing unit, the temperature of the air or gases enclosed therein can reach and exceed 70° C. These high temperatures trigger significant pressure variations within the sealed areas between the two glass panes, causing movements and curvatures of the individual glass panes that make up the glazing unit; in turn the glass panes cause high stress in the glass and on the sealants.

In particular, in single sealed double/triple glazing units, breakages or loss of structural soundness may occur due to the said high temperatures reached inside.

Furthermore, when high thermal performance double/triple glazing units are used, the difference in temperature between the internal and external glass surface is greater. In winter, the temperature of the surface of the external glass may be −30° C., while the internal one may be +18° C. Because of this high thermal gradient, the difference of thermal expansion of the two glass panes is greater, placing higher mechanical stress on the external sealant which over time can crack, losing its sealing capacity. Consequently, in the case of infiltration of moisture and condensation inside the low-emissivity double/triple glazing unit due to the detachment and rupture of the external sealant, the low-emissivity glass coatings with silver based compounds will oxidize rapidly, becoming opaque and whitish.

Among the various drawbacks there is also the fact that external sealants such as polyurethane, silicone and polysulphide materials are relatively permeable to noble gases such as argon and krypton, therefore over time a gas leak forms, resulting in the loss of thermal performance.

In addition, it has been found that the protective low-emissivity layers of high thermal performance glass intercept harmful solar ultra-violet radiation (UV), preventing them from entering the buildings. In return, when these barriers are applied within or on the central glass panes of the glazing units with two or more layers, there is a concentration of ultraviolet rays within the glazing units. The plastic and thermoplastic materials placed inside the glazing unit may undergo progressive thermo-mechanical deterioration due to exposure to this high level of UV radiation.

Despite the fact that these problems have been found to be more critical for high thermal performance double/triple glazing units, the said problems also reduce, to a lesser extent, the performance of the external sealants of double/triple glazing units made with conventional technology.

The use of “warm edge” spacers has allowed to reduce and limit the drawbacks previously described, but has given rise to new problems in the processing phase, different from those typical of metal spacers (cut or bent).

The main difficulties encountered in the production phase and during useful life are due to the fact that their internal cross-section is smaller, and therefore—with the same length—they contain a quantity of desiccant salt that sometimes is much lower; over time, this reduces the capacity to absorb the moisture present or that forms between the glass panes.

In addition, the high flexibility of the frame requires good manual skills to handle and apply the glass without causing any deformation that may result in distortions, lack or abundance of external sealant on the finished product; if the sealant is abundant it may compromise the appearance of the product while if it is lacking it will reduce the seal against humidity.

In particular, in the bending phase it is necessary to pay particular attention to the corners as regards squaring and ensuring that they do not exceed the width of the spacer, which can cause problems in the application of the internal sealant and in the subsequent pressing phase; the application of the butyl must be checked carefully, as regards the different shape, and the flexibility of the frame.

Another limitation highlighted is the fact that the adhesion test of the external sealants must be performed with great care, paying attention to the possible detachment of the two materials that make up the spacer.

In addition, changes must be made to the profile bending machines, cutters and drills, because appropriate tools are required due to the hardness of the steel back and the characteristics of the plastic material; furthermore, the residues from the drilling of the plastic part may block the holes made with the machine that introduces the desiccant or inert gas, thus preventing or hindering the filling operation. Furthermore, for the introduction in the double/triple glazing units of low thermal conductivity gas, it is necessary to use correctly sized holes with sealing systems; great care must be taken when making the holes for the exchange of air between the spacer and the internal cavity, and its functionality must be tested.

In addition to the processing problems, the materials that make up the rigid “warm edge” spacers frequently have different coefficients of linear expansion, therefore when the temperature varies inside the double/triple glazing unit, the stress on the butyl seal increases and this reduces the important protection of the glazing unit against the loss of gas, and possible infiltration of humidity from the outside.

The “flexible” spacers currently available on the market also present problems. In fact, it is difficult to obtain a uniform and constant application of the internal sealant on both sides of the foams due to the low elasticity of the spacer. Furthermore, the spacer may not have a constant and uniform shape and geometry and may not be adequately resistant in the pressing phase of the double/triple glazing unit, due to the low elastic modulus and hardness achieved with flexible silicone or thermoplastic foam spacers.

In addition, difficulties have been encountered in the closure of the joint, which must be carried out at the end of the application of the spacer and must be hermetically sealed against humidity and low conductivity gases; difficulties have also been encountered in the adhesion of the flexible spacer to the external sealant, usually achieved by applying an external metal barrier that is atmospheric humidity proof and gas proof; additional difficulties concern the high permeability of foams and rubbers to low thermal conductivity gases.

### DISCLOSURE OF INVENTION

The aim of the present invention is essentially to solve the problems of the known technique overcoming the above mentioned difficulties by means of a flexible spacer for double glazing that offers lower thermal conductivity, whereby the double/triple glazing unit will not feature condensation along the perimeter, not even in extreme winter weather conditions.

A second aim of the present invention is to create a flexible spacer for double/triple glazing units able to reduce the heat loss rate from the perimeter of the unit and to place lower thermal stress in the glass panes that make up the double/triple glazing unit when there are changes in temperature and pressure in the air chamber, enclosed between two adjacent glass panes.

Another aim of the present invention is to create a flexible spacer for double/triple glazing units which is more elastic, yielding and flexible and that allows to compensate, without increasing internal stress in the glass panes and external sealants, the fluctuations in pressure inside the double/triple glazing unit caused when high temperatures are reached, and also to compensate, without placing greater stress on the external sealant, the different thermal expansion between the outside and inside glass of the multilayer glazing unit.

A further aim of the present invention is to provide a flexible spacer for double/triple glazing units that contributes to maintain the structural soundness and the soundness of the external seal, reduces mechanical stress on the external sealant, extending its life and effectiveness in time, and prevents the leakage of low conductivity gas from the inside of the double/triple glazing unit.

A further but not final aim of the present invention is to create a flexible spacer for double/triple glazing units that is easy to manufacture and works well and that allows to considerably simplify the assembly of the insulating double/triple glazing units.

These aims and others besides, which will better emerge over the course of the present description, are essentially achieved by means of a flexible spacer for double glazing, as outlined in the claims below.

### BRIEF DESCRIPTION OF DRAWINGS

Further characteristics and advantages will better emerge in the detailed description of a flexible spacer for double glazing according to this invention, provided in the form of a non-limiting example, with reference to the accompanying drawings, in which:

FIG. 1 shows a partially sectioned view of a window and of a double/triple glazing unit;

FIGS. 2A, 2B and 2C show, schematically and from a front view, a flexible spacer for double/triple glazing units according to the present invention;

FIG. 3 shows a sectioned view of the spacer in FIG. 2 fitted in double and triple glazing;

FIG. 4 shows, schematically, a front view a variant of the spacer in FIG. 2;

FIG. 5 shows, schematically, a sectioned view of the spacer in FIG. 4 fitted in a double/triple glazing unit;

FIGS. 6A, 6B and 6C show respectively a method to achieve the corners of the spacer in question;

FIGS. 7A, 7B and 7C show respectively the use of the spacer in the corresponding FIGS. 6A, 6B and 6C.

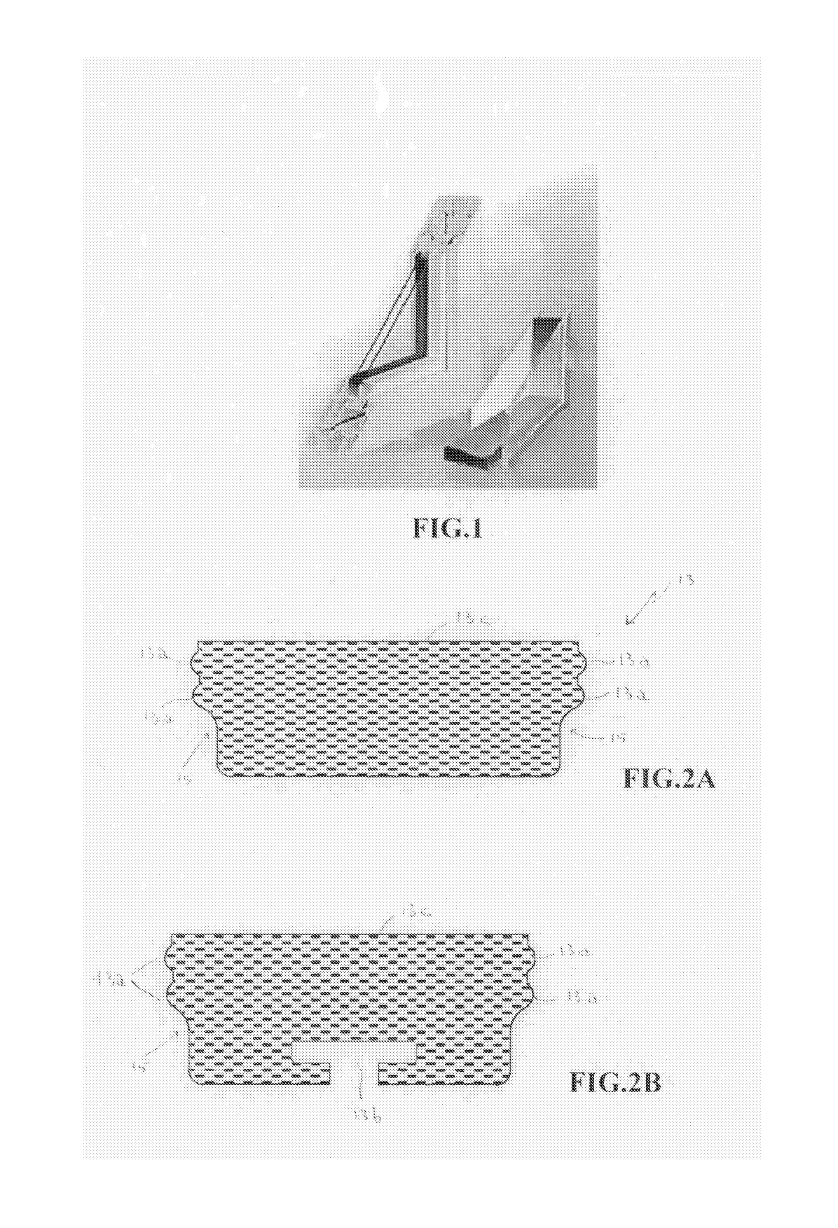

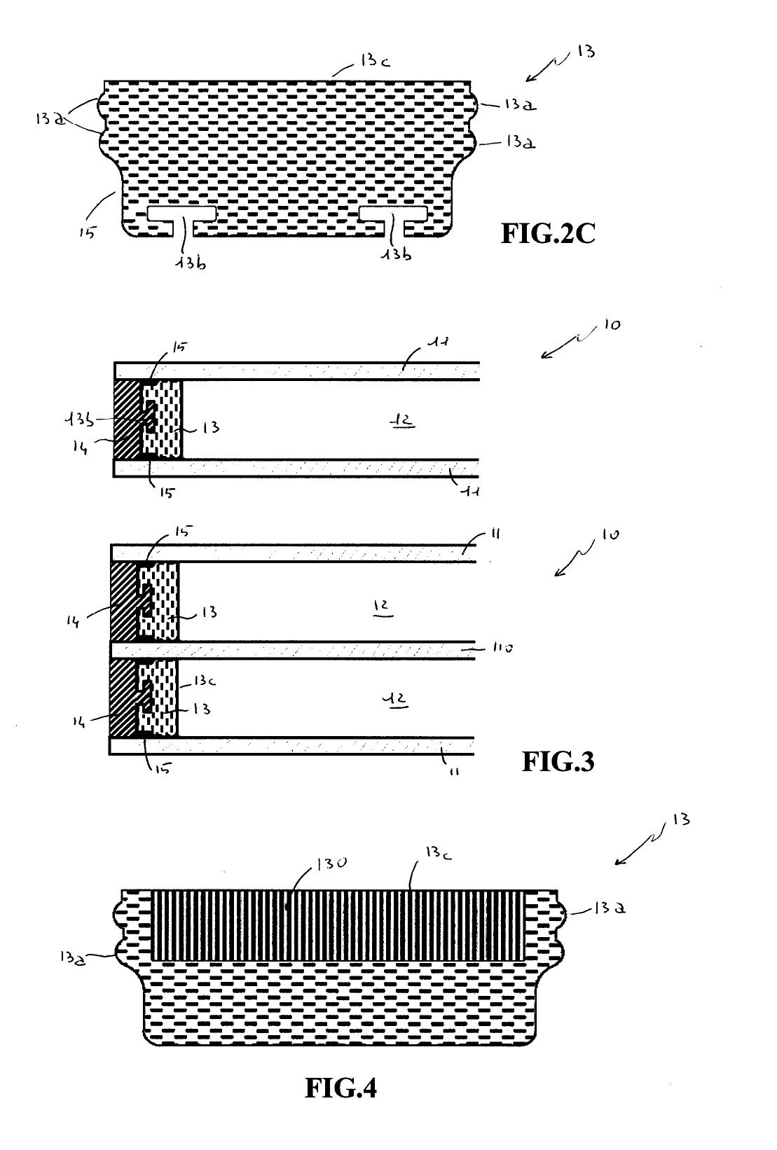

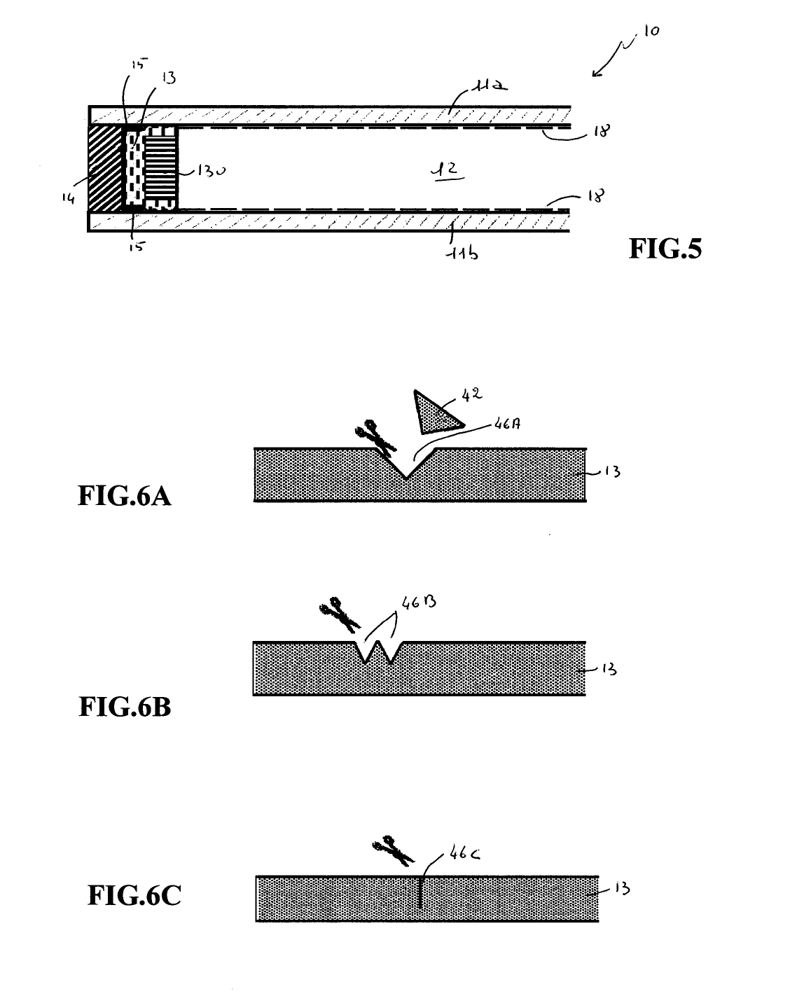

With reference to the above mentioned figures, and in particular FIG. 2, 13 denotes, as a whole, flexible spacer for double/triple glazing according to the present invention.

### BEST MODE FOR CARRYING OUT THE INVENTION

As mentioned previously, the present invention refers to the production of high thermal insulation performance glazing units with two or more layers. As shown in FIG. 3, a double/triple glazing unit 10 is substantially constituted of at least a pair of glass panes 11 in which the glass panes are spaced parallel from each other by a peripheral sealant, insulating material and spacer assembly, with high mechanical strength, which encloses a certain volume of insulating air 12 between the adjacent glass panes. The spacer, sealant and insulating material assembly comprises an internal spacer 13 pressed between two glass panes, positioned peripherally towards the inside of the edges of the glass panes, creating a perimeter channel towards the outside, between the glass panes, which is filled with external or secondary sealant 14.

Spacer 13 is made of flexible or semi-rigid cross-linked elastomer, impermeable to moisture and with high low thermal conductivity gas sealing capacity, and incorporates moisture absorbing material. The spacer is particularly resistant to UV radiation, ozone and heat, and has low thermal conductivity typical of elastomers with inert mineral fillers. A further important property of the spacer is its flexibility, which allows it to be simply wound on a reel. Its elasticity and hardness can be duly modified by amending the recipe of the elastomeric mixture.

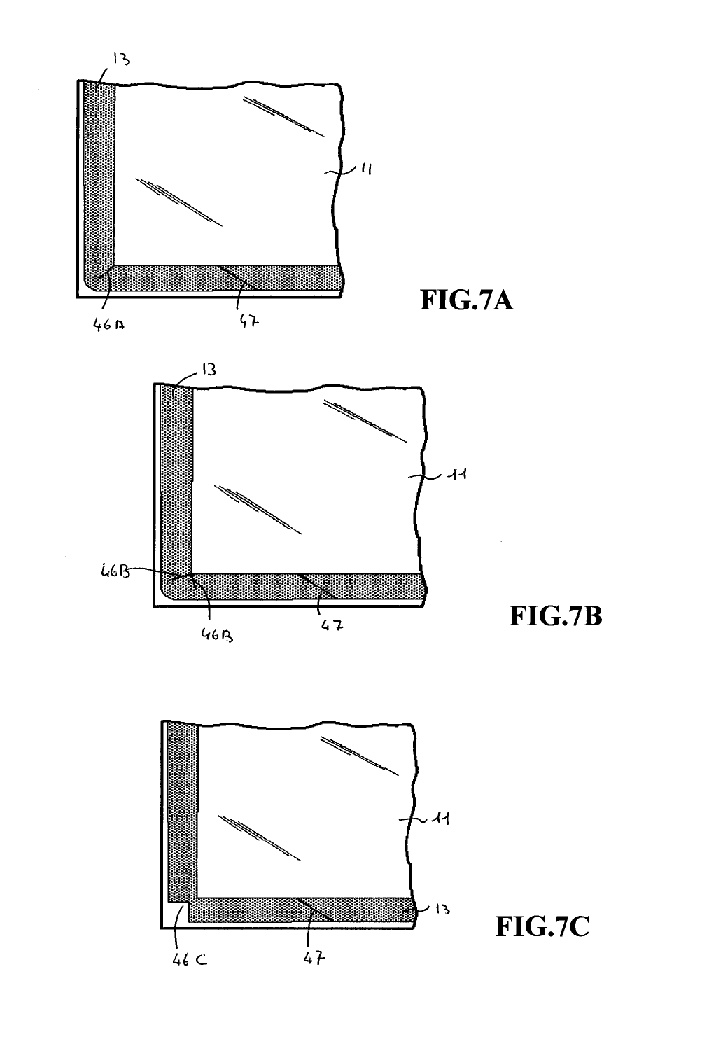

In the manufacture of a double/triple glazing unit, the flexible spacer is typically applied automatically along the perimeter of the unit, through continuous application and it is bent, curved and carved to create angles so as to maintain intact the intrinsic characteristics as barrier to steam and gases as shown in FIGS. 6A, 6B and 6C and in FIGS. 7A, 7B and 7C.

When external sealants permeable to moisture are used, such as polyurethanes, silicones and polysulphides, a thin layer of polyisobutylene is used to hermetically seal the internal chamber thus created. The said layer of polyisobutylene, applied between the edges of the spacer and the two glass panes, also acts as strong action adhesive to hold the spacer/glass assembly before the application of external sealant.

For high thermal performance applications, the multilayer glazing units incorporate at least one low emissivity glass 110 facing each internal air chamber, and each air chamber is filled with a low conductivity inert gas such as, for example, argon.

For triple or quadruple glazing units, to avoid problems of internal pressure stress, the glazing units can be filled with low-conductivity gas such as krypton or xenon. The advantage of using these inert gases lies in the fact that the distance between the two glass panes, necessary to obtain good thermal performance, may be reduced, bringing the optimum distance between two adjacent glass panes to 12 mm.

In addition, in order to obtain high thermal performance, the internal air chambers must be filled with inert gases, and one side of the glass facing each internal separate air chamber must be coated with a layer of low emissivity coating 18.

In accordance with the present invention, the flexible or semi-rigid spacer 13 is made of Polyisobutylene elastomer or butyl rubber IIR (simple or halogenated), suitably loaded with both reinforcing and inert fillers. In addition it can be cross-linked with sulphur or peroxides to confer physical-mechanical elasticity.

In more detail, the butyl rubber is a copolymer of isobutylene with isoprene, the latter being contained in a minimum proportion. Its average molecular weight ranges from 300,000 to 600,000; the isoprene content varies from 0.50% to 3.50% by weight.

The said elastomer has advantages, such as high impermeability to air and other gases, excellent insulating power, low compression set and high flexibility even at low temperatures; because of its low degree of unsaturation, this elastomer is also resistant to ozone and atmospheric agents in general, heat, chemicals and moisture. The chlorinated or brominated butyl rubbers have the same characteristics as simple butyl rubber, sometimes they are even accentuated.

In particular, the spacer in question, being made of butyl rubber, does not require the addition of UV stabilisers since polyisobutylene is already highly resistant to ultraviolet radiation. In this way it is not therefore necessary to protect the inner face of the spacer from UV degradation, thus reducing the processing stages and keeping the production costs down.

In addition, with the flexible spacer according to the present invention it is not even necessary to apply a protective barrier that is impermeable to water vapour and inert gases, such as metal or plastic sheets, or metallised plastic films as is the case for the currently produced plastic warm edge spacers or those combined with metal laminates; the said flexible spacer therefore leads to a reduction in the components of the double/triple glazing unit which consequently leads to a further simplification in the production thereof.

Furthermore, the spacer 13, in view of its composition and configuration, can be bent without problems and without incurring the risk of the presence of folds or detachments as with the “warm edge” flexible spacers currently on the market, which require the presence of a protective barrier glued to the back of the spacer.

According to the present embodiment, the flexible spacer 13 has side walls that feature at least a small wave but for a better grip, the presence of multiple small waves 13a is foreseen, positioned immediately above the accumulation area of the internal or primary sealant 15, so as to ensure an optimal adhesion to the glass of the double/triple glazing unit within which the spacer is fitted; at the same time, the waves prevent the internal sealant, typically butyl, from leaking along the inner edge of the double/triple glazing unit, because of its relative low viscosity, causing an aesthetic and/or sealing defect.

The flexible spacer in question is highly compatible with and offers outstanding adhesion to the internal or primary sealant 15, typically butyl, while it has a fair compatibility with external or secondary thermosetting sealants 14, such as polysulphides, polyurethanes and silicone-based sealants. Experiments have shown that the most common external sealants adhere with moderate strength to the spacer 13. To obtain greater adhesion, the spacer features at least one recess 13b on the back. The recess 13b has a configuration such as to allow the external sealant to penetrate and create a strong mechanical bond between the two materials.

When the temperatures inside the double/triple glazing unit are very high, the flexible spacer maintains the thermal and mechanical stability of the whole structure, as it can withstand temperatures of up to +130° C.

In addition to what has been described above, the spacer is impermeable to humidity and water vapour, a feature that prevents the entry of moisture from outside the double/triple glazing unit but also prevents the absorption of water molecules from inside the chamber by the surface 13c, shown in FIG. 2. In order to ensure a high degree of absorption of the humidity within the air chamber of the double/triple glazing unit, and to prevent condensation therein during winter, the flexible spacer, according the present invention, envisages the presence of a sector 130 that comprises a second compound made of different elastomer, co-vulcanised with butyl rubber and which is permeable to moisture (e.g. EPDM, SBR, BR, NR and VMQ). In particular, the compound of which the sector 130 is composed contains a high quantity of desiccant salts and is thermally stable and resistant to UV rays, in this way the surface 13c will allow the humidity of the double/triple glazing unit to be absorbed within this sector.

The flexible spacer in question combines together or replaces four conventional characteristics required for a double/triple glazing unit in one single component: desiccant properties, metal spacer with internal cavity, corner connectors, and good adhesion to the internal and external sealants. As mentioned above, compared to the production of glazing units with conventional spacers, the manufacturing process of multilayer glazing units is simple, faster and straightforward.

In particular, for small double/triple glazing manufacturers, a particular advantage of using the flexible spacer lies in the fact that no particular mechanical device is required for its application. For larger manufacturers with highly automated double/triple glazing unit production lines, the advantages are multiplied: the flexible spacer can be supplied directly from a reel, followed by the automatic application of butyl, and subsequent application of the spacer along the edge of glass. It will no longer be necessary to fill the spacer with desiccant salts, as it already contains them; bending with a profile bending machine to achieve the corners or curvature of the insulating glass will also no longer be necessary.

As shown in FIGS. 6A and 7A, a simple V-shaped cut 46A located near the corner A of the glazing unit, a little deeper than half of the thickness, made removing a non-continuous part 42, or a double cut 46B, shown in FIG. 6B, allows the spacer to be easily bent at a right angle, as shown in FIG. 7B, while preserving the characteristics of impermeability to moisture and inert gases.

Furthermore, as shown in FIG. 6C, the spacer is cut with a simple vertical cut 46C that cuts one part and the corner is obtained by bending the opposite side of the cut material, as shown in FIG. 7C, maintaining also in this case the continuity of the material, and therefore all its characteristics. The internal end of the cut may present a small enlargement in the shape of a cavity to prevent the possible propagation of the cut during the bending process and the creation of the corner.

In addition to what has been described above, to join the two ends of the spacer and create the air chamber inside the double/triple glazing unit an oblique cut 47 is made, as shown in FIG. 7A, in order to create a larger contact surface, and the two ends are joined together by applying primary sealant between them.

With the spacer in question, linear and corner connectors such as those of the known technique are not necessary any more.

In the production process of double/triple glazing units, the spacer 13 is placed, after the application of butyl on the side, that is the application of the internal sealant, on the periphery of the first glass pane 11a, in such a way that the glass extends over the spacer by about 6 mm. The internal sealant 15 applied to the side, thanks to the strong adhesion to the glass and butyl rubber, allows the spacer 13 to remain in the assigned position by applying simple pressure.

The flexible spacer can also be easily cut with a knife, and—unlike the assembly of the spacer frame from pieces cut to size—the spacer 13 is placed directly on the glass pane and cut to size only after it has been put into position. The second glass pane 11b is positioned on the free edge of the spacer on which butyl has been applied (sealed) 15 to close the double glazing unit which then undergoes the pressing process. Following the application of the second glass pane, the process foresees the application of external or secondary sealant 14 within the channel that forms between the two glass panes 11a and 11b and the back of the spacer 13.

The high flexibility and elasticity of the spacer in question make it possible to place it in a straight line without any defect, even after a prolonged storage on a reel. The elastic rigidity of the spacer 13, coupled with a low compression set, allows the two parallel panes of the double glazing unit to be evenly spaced along the perimeter.

The spacer 13, compared to the rigid warm edge spacers, makes it possible to reach better performances in terms of thermal and acoustic insulation, resistance to natural ageing and higher gas retention. In fact the main characteristic of the spacer in question is its low thermal conductivity λ=0.20-0.40 W/(m° K), which guarantees a lower transmittance value of the double/triple glazing unit. This means that the internal temperature of the surface is higher, in particular of the lower profile, typically by as much as 9.2 degrees with respect to aluminium (simulated data with an outside temperature of −18° and an internal one of +21°); all this translates into a significant improvement in the Uw (thermal transmittance) value of the window/door frame.

In addition to what has been described above, the spacer 13 is fully recyclable since, at the end of its life cycle, it can be detached from the glass, ground and reused to produce other spacers or used in other sectors that adopt butyl rubber.

Thus the present invention achieves the aims set.

In fact, the flexible spacer in question offers a lower thermal conductivity therefore the double/triple glazing unit does not present any condensation along the perimeter even in extreme winter weather, unlike what used to happen with the metal spacers and rigid plastic spacer profiles.

Advantageously, the flexible spacer for double glazing units allows to reduce the rate of heat loss from the perimeter of the unit and to offer lower thermal stress in the glass panes that constitute the double glazing unit, in the case of changes in temperature and pressure in the air chamber enclosed between two adjacent glass panes.

In addition, the flexible spacer according to the present invention is more elastic, yielding and flexible compared to plastic profiles or profiles coupled with metal sheets of the known technique.

In particular, the flexible spacer allows to compensate, without increasing internal stress in the glass panes and external sealants, the fluctuations in pressure inside the double/triple glazing unit caused when high temperatures are reached, and also to compensate, without placing greater stress on the external sealant, the different thermal expansion between the outside and inside glass of the multilayer glazing unit.

In addition, the flexible spacer for double/triple glazing units contributes to maintain the structural soundness and the soundness of the external seal and reduces mechanical stress on the external sealant, extending its the life and effectiveness in time, and prevents the leakage of low conductivity gas from the inside of the double/triple glazing unit.

Advantageously, the spacer in question is able to withstand prolonged exposure to the high levels of UV radiation that are reached inside the double/triple glazing units containing low emissivity coatings of the internal glass, unlike what used to happen with the plastic spacers that needed to be protected with coatings or special UV stabilizers.

In addition, with the spacer according to the present invention it is not necessary to use protective barriers in metal or other material on the back of the spacer, as used to happen with spacers of the known technique, because it is impermeable to moisture and gases. This makes it possible to avoid all those detachments of the barrier due to corner bending or curvature of both rigid and flexible traditional spacers, and to avoid the loss of adhesion between the protective barrier and body of the spacer due to both physical and thermal ageing.

A further advantage of the spacer is that it greatly simplifies the assembly of the double/triple glazing units also thanks to the fact that insertion of both linear and angular connectors is eliminated, as well as the introduction of desiccant salts in the cavity inside the spacers of the known technique.

In addition, the compressibility of the spacer in question enables to significantly reduce the manufacturing tolerances, and the high flexibility allows the spacer to be wound on a reel and used in a highly automated double/triple glazing production process.

An advantage obtainable using the flexible elastomeric spacer to produce high thermal performance double/triple glazing units containing noble gases such as krypton or xenon, lies in the possibility of reducing the total thickness of the units while obtaining the same thermal performance U_{g}; this is possible because the thermal transmittance of the edge of the double/triple glazing unit with an elastomer spacer, which is up to 3-4 mm less thick than conventional rigid warm-edge spacers, is the same. This results in a reduction in weight of the window/door. In addition, the spacer is less wide (about 12 mm) compared to the “warm edge” spacers (about 16 mm), thus obtaining optimum thermal performance with a consequent reduction of external sealant which allows to reduce the weight, total thickness of the double/triple glazing unit and to keep the production costs down.

A further but not final advantage is given by the fact that the flexible spacer is easy to use, easy to manufacture and works well, and does not require maintenance. Furthermore, the flexible spacer according to the present invention has a remarkably simple structure and this allows to keep the manufacturing costs low also thanks to the fact that it is no longer necessary to use connectors.

Naturally, further modifications or variants may be applied to the present invention while remaining within the scope of the invention that characterises it.

1) Flexible spacer for double glazing characterised by the fact that the said flexible or semi-rigid spacer (13) is made of Polyisobutylene elastomer or butyl rubber IIR (simple or halogenated), suitably loaded with both reinforcing and inert fillers, which can be cross-linked with sulphur or peroxides, that the said spacer is impermeable to moisture and has high low thermal conductivity gas sealing capacity, and incorporates moisture absorbing material, that each side wall of the said spacer features at least a small wave (13a) positioned immediately above the accumulation area of the internal or primary sealant (15) so as to ensure an optimal adhesion to the glass of the double/triple glazing unit within which the spacer is fitted.

2) Flexible spacer for double glazing, according to claim 1, characterised by the fact that it features a sector (130) that comprises a second compound made of different elastomer, co-vulcanised with butyl rubber, which is permeable to moisture, contains a high quantity of desiccant salts and is thermally stable and resistant to UV rays, so as to allow the surface (13c) to absorb a greater amount of humidity from the double/triple glazing within this elastomer.

3) Flexible spacer for double glazing, according to claim 1, characterised by the fact that it features at least one recess (13b) on the back, with a configuration such as to allow the external sealant to penetrate and create a strong mechanical bond between the two materials.

4) Flexible spacer for double glazing, according to claim 1, characterised by the fact that it is bent, curved and carved to create corners so as to maintain intact the intrinsic characteristics as barrier to steam and gases, that the said spacer features a V-shape (46A) cut located near the corner A of the glazing unit, a little deeper than half of the thickness, made by removing a non-continuous part 42, or features a double cut (46B) to easily bend the spacer at a right angle, or features a simple vertical cut (46C) that cuts one part and the corner is obtained by bending the material on the opposite side of the cut, and an oblique cut (47) that is made to join the two ends of the spacer and create the air chamber inside the double/triple glazing, in order to create a larger contact surface, and the two ends are joined together by applying primary sealant between them.

5) Flexible spacer for double glazing, according to claim 1, characterised by the fact that it prevents the internal sealant from leaking along the inner edge of the double/triple glazing unit, because of its relative low viscosity.

6) Flexible spacer for double glazing, according to claim 1, characterised by the fact that it features high impermeability to air and other gases, excellent insulating power, low compression set and high flexibility even at low temperatures and that is particularly resistant to ozone and atmospheric agents in general, heat, chemicals UV radiation and moisture.

7) Flexible spacer for double glazing, according to claim 1, characterised by the fact that when the temperatures inside the double/triple glazing unit are very high, the flexible spacer maintains the thermal and mechanical stability of the whole structure, as it can withstand temperatures of up to +130° C.

8) Flexible spacer for double glazing, according to claim 1, characterised by the fact that it is less wide to ensure optimal thermal transmittance performance.

9) Flexible spacer for double glazing, according to claim 1, characterised by the fact that it is flexible and can be easily wound on a reel.
